(19) United States
(12) Patent Application Publication
(10) Pub. No.: US 2010/0151171 A1
(43) Pub. Date: Jun. 17, 2010

(54) CONNECTOR FOR THERMAL INSULATION TUBE

(75) Inventor: Ravina VITOORAPAKORN, Samut Prakan (TH)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: EASTERN POLYMER INDUSTRY COMPANY LIMITED, Samut Prakan (TH)

(21) Appl. No.: 12/413,706

(22) Filed: Mar. 30, 2009

(30) Foreign Application Priority Data
Dec. 17, 2008 (TH) 0803001497

(51) Int. Cl. B32B 3/26

(52) U.S. Cl. 428/36.8; 428/36.91

(57) ABSTRACT

A connector for a thermal insulation tube comprises an annular middle portion made from a polymer with thermal insulation properties. The middle portion has two opposite annular surfaces. One of the surfaces is covered with a first adhesive layer while the other annular surface is covered with a second adhesive layer. A first cover sheet is attached to the first adhesive layer. The first adhesive layer used to attach the end surface of the first thermal insulation tube is exposed if the first cover sheet is peeled off. A second cover sheet is attached to the second adhesive layer. The second adhesive layer used to attach the end surface of the second thermal insulation tube is exposed if the second cover sheet is peeled off.

### BACKGROUND OF THE INVENTION

The present invention relates to a connector for a thermal insulation tube.

Generally, a thermal insulation tube is a hollow cylindrical polymeric member made from a synthetic polymer such as ethylene propylene diene monomer (EPDM) or acrylonitrile butadiene rubber (NBR). The thermal insulation tube is used to insulate cool and hot water pipes and the like. An installation method includes putting the tube on a pipe to be insulated. In case the pipe to be insulated has already been assembled into a piping structure, the operator has to cut the thermal insulation tube along its longitudinal axis and wrap the pipe to be insulated. The operator then uses a brush to apply an adhesive to the cut surface to hermetically seal the thermal insulation tube along the entire cut. In order to connect the end of one thermal insulation tube to that of another thermal insulation tube, the operator has to apply the adhesive to the end surfaces of both thermal insulation tubes to be connected. The operator then presses the ends of both thermal insulation tubes together. This connecting method suffers from the problems of the adhesive tainting the mounting site and the operator inhaling a volatile organic compound (VOC) contained in the contact-cement adhesive, which is generally a hydrocarbon volatile compound harmful to a person's health in the long run. The latter becomes more serious when the installation is done at a site with limited space. In addition, applying the adhesive also requires skills to hermetically attach the ends of the thermal insulation tubes, i.e., once the adhesive is applied, since it does not instantly become tacky. There is a waiting period for the adhesive to become tacky before the ends of the thermal insulation tube are pressed to connect. The installation process thus takes a long time. It is therefore necessary to provide a means to connect the ends of the thermal insulation tube that can overcome the above problems.

### BRIEF SUMMARY OF THE INVENTION

The present invention provides a connector for a thermal insulation tube. The connector is used for connecting a first thermal insulation tube to a second thermal insulation tube. The first and second thermal insulation tubes are made from a polymer and comprise: a middle portion; a first adhesive layer; a first cover sheet; a second adhesive layer; and a second cover sheet; where the middle portion is an annular member made from a polymer and having thermal insulation properties; the inner diameter of the middle portion is defined to conform to the pipe to be insulated; the middle portion has two opposite annular surfaces, one of which is covered with the first adhesive layer while the other annular surface is covered with the second adhesive layer; the first adhesive layer is located between the first cover sheet and the middle portion; the first cover sheet is an annular sheet of which inner diameter conforms to the pipe to be insulated; the first cover sheet is attached to the first adhesive layer; the first adhesive layer used to attach the end surface of the first thermal insulation tube is exposed if the first cover sheet is peeled off; the second adhesive layer is located between the second cover sheet and the middle portion; the second cover sheet is an annular sheet having an inner diameter which conforms to the pipe to be insulated; the second cover sheet is attached to the second adhesive layer; the second adhesive layer used to attach the end surface of the second thermal insulation tube is exposed if the second cover sheet is peeled off.

An object of the present invention is to provide a connector for a thermal insulation tube having an easy, convenient, and quick usage. The ends of the thermal insulation tubes are hermetically attached without a brush or an adhesive application to avoid the problem of the operator inhaling the hydrocarbon VOCs that harms the operator's health and to alleviate the installation problems of an unskilled operator.

Another object of the present invention is to provide a connector for the thermal insulation tube, the connector having a thickness which ranges from 2 mm to less than 6 mm. The middle portion is made from an elastic polymer with a radial cut. This is thus suitable for installing to a pipe to be insulated which has already been assembled into a piping structure.

Another object of the present invention is to provide a connector for the thermal insulation tube, the connector having a thickness range from 6-50 mm. The middle portion is made from an elastic polymer, and comprises a radial cut. A third adhesive layer is provided at the cut and a third cover sheet. The third adhesive layer is used to attach the opposite surfaces at the cut to avoid a gap at the cut. This will result in moisture impermeability and prevent any heat loss from the pipe to be insulated through the cut.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a schematic front perspective view showing the components of the connector for the thermal insulation tube according to the present invention;

FIG. 2 is a schematic front perspective view showing the components of the connector for the thermal insulation tube according to another embodiment of the present invention;

FIG. 3 is a schematic front perspective view showing the components of the connector for the thermal insulation tube according to another embodiment of the present invention;

FIG. 4 is a schematic front perspective view showing the components of the connector for the thermal insulation tube according to another embodiment of the present invention after the connector for the thermal insulation tube is opened into a C-shape;

FIG. 5 is a schematic side perspective view showing an installation method of the connector for the thermal insulation tube according to the present invention;

FIG. 6 is a schematic side perspective view showing an installation method of the connector for the thermal insulation tube according to another embodiment of the present invention;

FIG. 7 is a schematic side view showing a connector for the thermal insulation tube according to the present invention after the first and second thermal insulation tubes are connected to each other;

FIG. 8 is a schematic side perspective view showing an installation method including a step of wrapping the adhesive tape around the seam of the thermal insulation tube.

### DETAILED DESCRIPTION OF THE INVENTION

The present invention provides a connector for a thermal insulation tube to connect a first thermal insulation tube 11 to a second thermal insulation tube 12. The first thermal insulation tube 11 and the second thermal insulation tube 12 are both made from polymer.

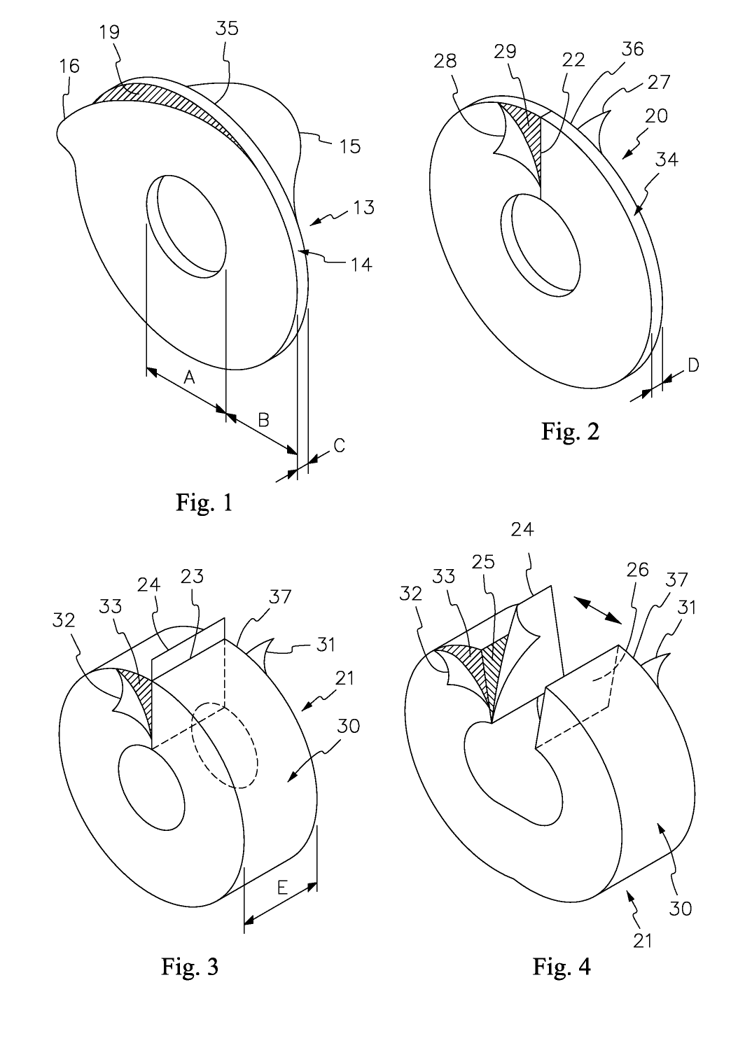

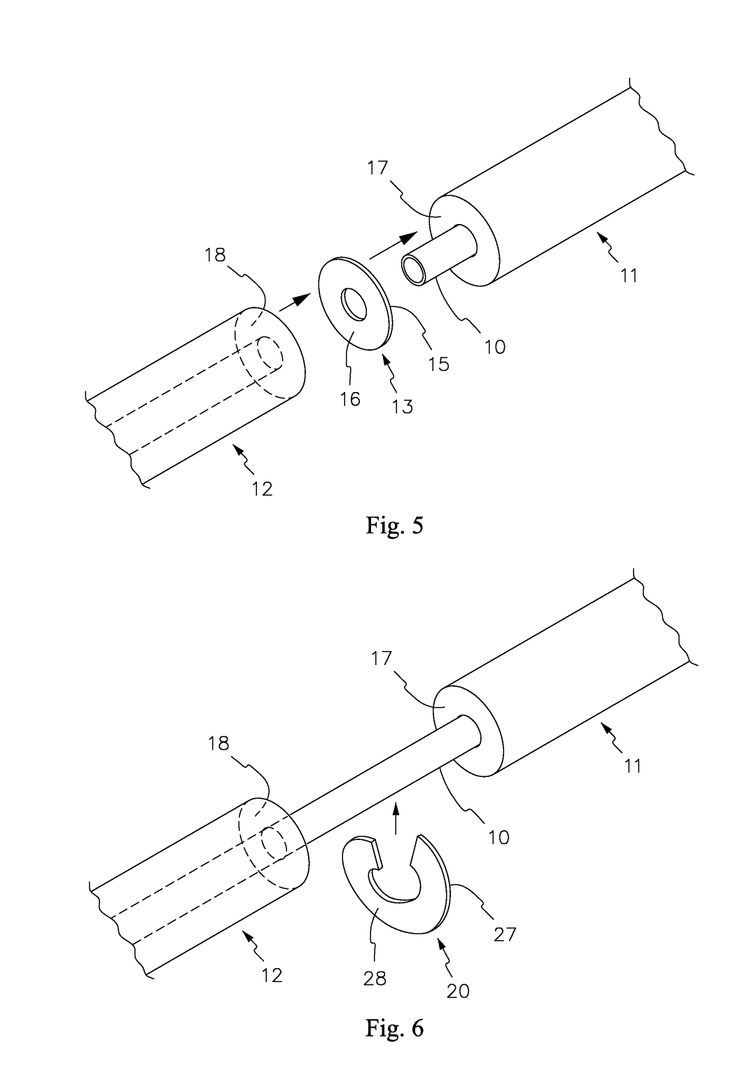

FIG. 1 shows the connector 13 for the thermal insulation tube according to the present invention comprising: a middle portion 14; a first adhesive layer 35; a first cover sheet 15; a second adhesive layer 19; and a second cover sheet 16; wherein the middle portion 14 is an annular member made from a polymer with thermal insulation properties; the inner diameter of the middle portion is defined to conform to the pipe to be insulated 10 as shown in FIG. 5; the middle portion 14 has two opposite annular surfaces, one of which is covered with the first adhesive layer 35 while the other annular surface is covered with the second adhesive layer 19; the first adhesive layer 35 is located between the first cover sheet 15 and the middle portion 14; the first cover sheet 15 is an annular sheet with an inner diameter which conforms to the pipe to be insulated 10; the first cover sheet 15 is attached to the first adhesive layer 35; the first adhesive layer 35 is used to attach the end surface 17 of the first thermal insulation tube 11 as shown in FIG. 5; the first adhesive layer 35 is exposed when the first cover sheet 15 is peeled off. The first cover sheet 15 is made from a silicone coated paper and the like, where the silicone side is adjacent to the first adhesive layer 35; and the second adhesive layer 19 is located between the second cover sheet 16 and the middle portion 14. The second cover sheet 16 is an annular sheet with an inner diameter which conforms to the pipe to be insulated 10; the second cover sheet 16 is attached to the second adhesive layer 19; the second adhesive layer 19, as shown in FIG. 1, is used to attach the end surface 18 of the second thermal insulation tube 12, as shown in FIG. 5. The second adhesive layer 19 is exposed when the second cover sheet 16 is peeled off. The second cover sheet 16 is made from a silicone coated paper or a silicone coated plastic and the like, where the silicone side is adjacent to the second adhesive layer 19.

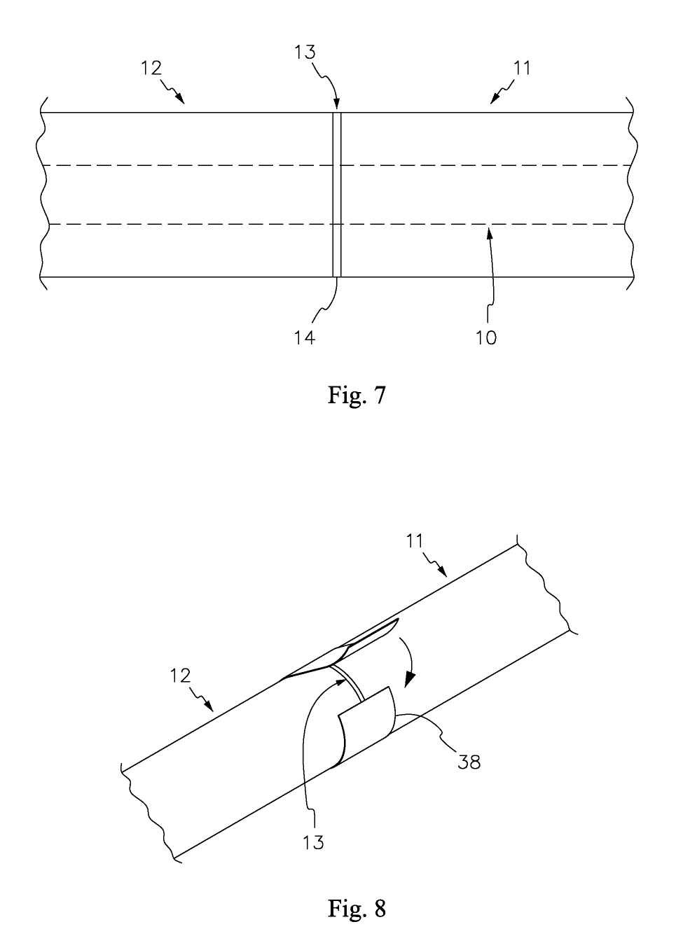

FIG. 5 shows an installation method for the connector 13 for connecting thermal insulation tubes according to the present invention, the method comprising the steps of: putting or wrapping the first thermal insulation tube 11 onto the pipe 10 to be insulated; peeling the first cover sheet 15 to uncover the first adhesive layer 35; putting the connector 13 for the thermal insulation tube on the pipe 10 to be insulated and pressing the connector 13 to attach the first adhesive layer 35 to the end surface 17 of the first thermal insulation tube 11; peeling the second cover sheet 16 from the middle portion 14 to uncover the second adhesive layer 19; putting or wrapping the second thermal insulation tube 12 onto the pipe 10 to be insulated and pressing the end surface 18 of the second thermal insulation tube 12 to the second adhesive layer 19. The complete installation is shown in FIG. 7; then, the adhesive tape 38 is wrapped to cover the seam as shown in FIG. 8, the adhesive tape 38 being made from a material, such as synthetic rubber, with moisture impermeability properties.

The present invention provides a middle portion 14, a first cover sheet 15, and a second cover sheet 16 with the same inner and outer diameters. The inner diameter ranges from 6-200 mm as indicated by the dimension A in FIG. 1. The width of the annular shape ranges from 6-150 mm as indicated by the dimension B in FIG. 1. The thickness of the connector for the thermal insulation tube measured from the outer surface of the first cover sheet to the outer surface of the second cover sheet ranges from 2-50 mm as indicated by the dimension C in FIG. 1. The materials used for the middle portion 14 include various types of polymers with thermal insulation properties such as synthetic rubber and plastic. Ethylene propylene diene monomer (EPDM) and acrylonitrile butadiene rubber (NBR) are examples of synthetic rubber while polystyrene foam and polyethylene foam are examples of plastic. The first adhesive layer 35 and the second adhesive layer 19 can be obtained by coating adhesive on the annular surface or by attaching double-sided adhesive tape on the annular surface, etc. In addition, the first thermal insulation tube 11, the second thermal insulation tube 12, and the middle portion 14 may be made from the synthetic rubber. The present invention provides an additional property of the adhesive that is coated on the annular surface or on the double-sided adhesive tape. The additional property includes melting (fusing) the synthetic rubber of the middle portion 14, first thermal insulation tube 11, and the second thermal insulation tube 12 to hermetically and homogeneously join the thermal insulation tubes together. The term “melting” or “fusing” is the ability of the adhesive to dissolve the synthetic rubber. This effect can be referred to as the law of “like dissolves like.” This law is based on the fact that polar materials are highly dissolvable in polar solvents and that, likewise, non-polar materials are highly dissolvable in non-polar solvents. Thus, the first thermal insulation tube 11, the second thermal insulation tube 12 and the middle portion 14 can be made of a synthetic rubber with non-polar properties and therefore be highly dissolvable with an adhesive having non-polar properties as well.

The adhesive utilized in the present invention can include two major components, such as, a low molecular weight hydrocarbon compound and a solvent. The solvent is preferably non-polar, but can be polar. If the solvent is non-polar, it can effectively dissolve non-polar rubber mass, such as, for example, the EPDM rubber. In addition, after dissolution of the rubber, once the solvent evaporates and the adhesive becomes dry, the dissolved portion of the rubber will become homogeneous. The homogeneity process is complemented with the hydrocarbon compound of the adhesive acting as a binder. If the solvent utilized is non-polar, this adhesive would only slightly dissolve a polar rubber, such as NBR rubber. Thus, this type of adhesive can be used to attach the polar rubber, but the attachment would not be as strong as on a non-polar rubber. The adhesive is selected to adhere to the thermal insulation tubes and the middle portion. Preferably, a polar adhesive, which contains a polar solvent, is preferably matched with a polar rubber while a non-polar adhesive, which contains a non-polar solvent, is preferably matched with a non-polar rubber.

FIG. 2 shows the connector 20 for a thermal insulation tube having a similar appearance and components as those of the connector for the thermal insulation tube 13, with the following features. The thickness of the connector 20 for thermal insulation tube measured from the outer surface of the first cover sheet 27 to the outer surface of the second cover sheet 28 ranges from 2 mm to less than 6 mm as indicated by the dimension D as shown in FIG. 2. The middle portion 34 is made from an elastic polymer such as various types of synthetic rubber or polystyrene foam, and the like. The connector 20 for the thermal insulation tube is provided with a radial cut 22 to allow the operator to open the connector 20 for the thermal insulation tube into a C shape as shown in FIG. 6 and then mount the connector onto the pipe 10 to be insulated. The connector 20 for the thermal insulation tube is suitable for the pipe to be insulated 10, which has already been assembled into a piping structure.

The cut 22 is made by cutting the connector 20 for the thermal insulation tube in the radial direction of the annular member using a cutting method such die cutting or cutting with a pair of scissors, etc.

The connector 20 for the thermal insulation tube is installed by mounting to the pipe 10 to be insulated, as shown in FIG. 6. Both surfaces along the cut line are then brought into contact with each other to resume the original condition of connector 20. The first cover sheet 27 is subsequently peeled off to couple the middle portion 34 to the first thermal insulation tube 11 and the second cover sheet 28 is peeled off to stick the middle portion 34 to the second thermal insulation tube 12. Once these members are in position, surfaces along the cut line will be in contact with each other and leave no gaps at the cut. The problems resulting from the condensation of moisture in the cavity into water drops and heat loss from the pipe to be insulated via the cut 22 are eliminated accordingly. These problems can be further reduced by attaching adhesive tape 38 around the seam.

FIG. 3 shows the connector 21 for the thermal insulation tube having similar appearance and components as those of the connector 13 for the thermal insulation tube with the following additional features. The thickness of the connector 21 for the thermal insulation tube measured from the outer surface of the first cover sheet 31 to the outer surface of the second cover sheet 32 ranges from 6-50 mm as indicated by the dimension E in FIG. 3. The middle portion 30 is made from various types of elastic polymers such as various types of synthetic rubber or polystyrene foam, and the like. The connector 21 for the thermal insulation tube is provided with a radial cut 23 to allow the operator to open the connector for the thermal insulation tube 21 into the C shape as shown in FIG. 4 and then mount the connector onto the pipe 10 to be insulated. The connector 21 for the thermal insulation tube is suitable for a pipe 10 to be insulated which has already been assembled into a piping structure. Substantial thickness of the connector 21 for the thermal insulation tube can result in the undesired condensation of moisture into water drops in the cavity of the cut 23. In order to prevent this kind of problem, the present invention provides the third adhesive layer 25 attached on one side of the cut surfaces of the middle portion 30 and third cover sheet 24 attached on the third adhesive layer. When the third cover sheet 24 is peeled off, the third adhesive layer 25 is exposed, as shown in FIG. 4. The third adhesive layer 25 is used to attach to the cut surface 26 of the middle portion 30 on the opposite side to avoid the gap at the cut line. The problem of condensation of moisture into water drops in the cavity of the cut is thus solved. The third adhesive layer 25 can be obtained, for example, by coating adhesive on the cut surface or by attaching double-sided adhesive tape on the cut surface. The adhesive that is coated on the cut surface or on the double-sided adhesive tape has the additional property of being able to melt (fuse) the synthetic rubber of the middle portion 30 to hermetically and homogeneously join the cut surfaces together. The third cover sheet 24 is made from silicone coated paper or silicone coated plastic, and the like, as mentioned above.

The cut 23 can be made by cutting the connector 21 for the thermal insulation tube in the radial direction of the annular member. The cutting method can be done by a cutting tool, a knife, etc.

The connector for the thermal insulation tube 21 is installed by mounting on the pipe 10 to be insulated. The third cover sheet 24 is subsequently peeled off to expose the third adhesive layer 25. The third adhesive layer 25 is then attached to the cut surface 26 of the middle portion. Subsequently, the first cover sheet 31 is peeled off to attach the middle portion 30 to the first thermal insulation tube 11 and the second cover sheet 32 is peeled off to attach the middle portion 30 to the second thermal insulation tube 12. The final step is wrapping the adhesive tape 38 around the seam.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A connector for thermal insulation tubes used in connecting a first thermal insulation tube to a second thermal insulation tube, the first thermal insulation tube and the second thermal insulation tube being made from a polymer, the connector comprising:
a middle portion;
a first adhesive layer;
a first cover sheet;
a second adhesive layer; and
a second cover sheet;
wherein
the middle portion comprises an annular member including a polymer with thermal insulation properties;
the inner diameter of the middle portion conforms to a pipe to be insulated;
the middle portion has a first and second opposite annular surfaces, a first annular surface is covered with the first adhesive layer and the second annular surface is covered with the second adhesive layer;
the first adhesive layer is located between the first cover sheet and the middle portion;
the first cover sheet is an annular sheet with an inner diameter which conforms to the pipe to be insulated;
the first cover sheet is attached to the first adhesive layer;
the first adhesive layer is used to attach an end surface of the first thermal insulation tube and becomes exposed if the first cover sheet is peeled off;
the second adhesive layer is located between the second cover sheet and the middle portion;
the second cover sheet is an annular sheet with an inner diameter which conforms to the pipe to be insulated;
the second cover sheet is attached to the second adhesive layer;
the second adhesive layer is used to attach an end surface of the second thermal insulation tube and becomes exposed if the second cover sheet is peeled off.

2. The connector for the thermal insulation tubes according to claim 1, wherein the first thermal insulation tube, the second thermal insulation tube, and the middle portion comprise a polymer, and wherein at least one of the first adhesive layer and/or the second adhesive layer is obtained by coating adhesive on a respective annular surface and the adhesive layers are configured to fuse the middle portion with the first thermal insulation tube and the second thermal insulation tube.

3. The connector for thermal insulation tubes according to claim 1, wherein the first thermal insulation tube, the second thermal insulation tube, and the middle portion comprise a polymer and wherein at least one of the first adhesive layer and/or the second adhesive layer is obtained by attaching double-sided adhesive tape on a respective annular surface, and the adhesive layers of the double-sided adhesive tape are configured to fuse the middle portion with the first thermal insulation tube and the second thermal insulation tube.

4. The connector for thermal insulation tubes according to claim 1, wherein the middle portion, the first cover sheet, and the second cover sheet have a same inner diameter ranging from 6-200 mm.

5. The connector for thermal insulation tubes according to claim 1, wherein the middle portion, the first cover sheet, and the second cover sheet have a same inner and outer diameters defining a width of an annular shape, the width ranging from 6-150 mm.

6. The connector for thermal insulation tubes according to claim 1, wherein the thickness of the connector as measured from an outer surface of the first cover sheet to an outer surface of the second cover sheet ranges from 2-50 mm.

7. The connector for thermal insulation tubes according to claim 1, wherein the thickness of the connector as measured from an outer surface of the first cover sheet to an outer surface of the second cover sheet ranges from 2 mm to less than 6 mm, the middle portion comprises an elastic polymer, and the middle portion comprises a radial cut that allows an opening of the connector into a C-shape during installation and subsequent mounting of the connector to the pipe to be insulated.

8. The connector for thermal insulation tubes according to claim 1, wherein the thickness of the connector as measured from an outer surface of the first cover sheet to an outer surface of the second cover sheet ranges from 6-50 mm, the middle portion comprises an elastic polymer, the middle portion comprises a radial cut that defines a first and second cut surfaces and which allows an opening of the connector into a C-shape during installation and subsequent mounting of the connector to the pipe to be insulated, the connector comprises a third adhesive layer attached on one side of the first or second cut surface, and the connector comprises a third cover sheet attached to the third adhesive layer such that removal of the third cover sheet results in exposure of the third adhesive layer for use in attaching the first cut surface and the second cut surface along a cut area defined by the radial cut.

9. The connector according to claim 2 wherein the polymer comprises synthetic rubber.

10. The connector according to claim 3 wherein the polymer comprises synthetic rubber.
